(19) United States
(12) Patent Application Publication
(10) Pub. No.: US 2025/0095195 A1
(43) Pub. Date: Mar. 20, 2025

(54) KEYPOINT DETECTION METHOD FOR MEDICAL IMAGING, AND MEDICAL IMAGING METHOD AND SYSTEM

(71) Applicant: GE Precision Healthcare LLC, Waukesha, WI (US)

(72) Inventors: Qingyu Dai, Beijing (CN); Ting Ye, Beijing (CN); Xiaolan Liu, Beijing (CN); Hao Yang, Beijing (CN); Ke Li, Beijing` (CN); Jian Cui, Beijing (CN)

(21) Appl. No.: 18/883,814

(22) Filed: Sep. 12, 2024

(30) Foreign Application Priority Data
Sep. 15, 2023 (CN) 202311200832.3

(51) Int. Cl. G06T 7/73; G06V 10/26; G06V 10/46

(52) U.S. Cl. CPC G06T 7/73; G06V 10/26; G06V 10/46; G06T 2207/10016; G06T 2207/10024; G06T 2207/10028; G06T 2207/10088; G06T 2207/30004; G06V 2201/03

(57) ABSTRACT

A keypoint detection method is provided for medical imaging, a medical imaging method and a medical imaging system. The keypoint detection method for medical imaging includes: receiving an image sequence, the image sequence comprising a plurality of images of an object; performing keypoint detection on the plurality of images separately, and generating a keypoint image sequence; performing keypoint occlusion detection on the images in the image sequence; and determining keypoint distribution information according to the keypoint image sequence and a result of the keypoint occlusion detection.

### CROSS REFERENCE TO RELATED APPLICATIONS

The present application claims priority and benefit of Chinese Patent Application No. 202311200832.3 filed on Sep. 15, 2023, which is incorporated herein by reference in its entirety.

### TECHNICAL FIELD

Embodiments of the present application relate to the technical field of medical devices, and in particular to a keypoint detection method for medical imaging, a medical imaging method and a medical imaging system.

### BACKGROUND

In a medical scenario, landmark points may refer to key coordinate points that are anatomically significant, typically junction points between different tissues and organs or recognition points that have the most distinctive morphological features in an object being studied. These landmark points may be used medically for tissue structure recognition. For example, in a magnetic resonance imaging (MRI) scenario, a landmark point of a scan object may be utilized to recognize a tissue or organ corresponding to the landmark point, thereby enabling determination of a region to be scanned in the scan object.

### SUMMARY

Provided in embodiments of the present application are a keypoint detection method for medical imaging, a medical imaging method and a medical imaging system.

According to one aspect of the embodiments of the present application, provided is a keypoint detection method for medical imaging. The method comprises: receiving an image sequence, the image sequence comprising a plurality of images of an object; performing keypoint detection on the plurality of images separately, and generating a keypoint image sequence; performing keypoint occlusion detection on the images in the image sequence; and determining keypoint distribution information according to the keypoint image sequence and a result of the keypoint occlusion detection.

According to one aspect of the embodiments of the present application, provided is a medical imaging method. The method comprises: determining keypoint distribution information according to the keypoint detection method for medical imaging described above; and performing a scanning operation according to the determined keypoint distribution information.

According to one aspect of the embodiments of the present application, provided is a medical imaging system. The system comprises: a controller, configured to perform the keypoint detection method for medical imaging described above; and a scanning assembly, performing a scanning operation according to keypoint distribution information determined by the controller.

One of the beneficial effects of the embodiments of the present application is that: keypoint detection is performed on a plurality of images in an image sequence separately, a keypoint image sequence is generated, keypoint occlusion detection is performed on the plurality of images in the image sequence, and keypoint distribution information is determined according to the generated keypoint image sequence and a result of the keypoint occlusion detection. Thus, the accuracy and reliability of the keypoint distribution information can be improved.

With reference to the following description and drawings, specific implementations of the embodiments of the present application are disclosed in detail, and the means by which the principles of the embodiments of the present application can be employed are illustrated. It should be understood that the embodiments of the present application are not limited in scope thereby. Within the scope of the spirit and clauses of the appended claims, the embodiments of the present application include many changes, modifications, and equivalents.

### BRIEF DESCRIPTION OF THE DRAWINGS

The included drawings are used to provide further understanding of the embodiments of the present application, which constitute a part of the description and are used to illustrate the implementations of the present application and explain the principles of the present application together with textual description. Evidently, the drawings in the following description are merely some embodiments of the present application, and a person of ordinary skill in the art may obtain other implementations according to the drawings without involving inventive skill. In the drawings:

FIG. 1 is a schematic diagram of a magnetic resonance imaging system according to an embodiment of the present application;

FIG. 2 is a schematic diagram of a keypoint detection method for medical imaging according to an embodiment of the present application;

FIG. 3 is a schematic diagram of an implementation of step 202 according to an embodiment of the present application;

FIG. 4 is a schematic diagram of a flow of step 202 according to an embodiment of the present application;

FIG. 5 is a schematic diagram of an occlusion state of a keypoint according to an embodiment of the present application;

FIG. 6 is a schematic diagram of an implementation of step 204 according to an embodiment of the present application;

FIG. 7 is a schematic diagram of an implementation of step 604 according to an embodiment of the present application;

FIG. 8 is a schematic diagram of an implementation of step 702 according to an embodiment of the present application;

FIG. 9 shows a keypoint detection apparatus for medical imaging according to an embodiment of the present application; and

FIG. 10 is a schematic diagram of a medical imaging method according to an embodiment of the present application.

### DETAILED DESCRIPTION

The foregoing and other features of the embodiments of the present application will become apparent from the following description and with reference to the drawings. In the description and drawings, specific implementations of the present application are disclosed in detail, and part of the implementations in which the principles of the embodiments of the present application may be employed are indicated. It should be understood that the present application is not limited to the described implementations. On the contrary, the embodiments of the present application include all modifications, variations, and equivalents which fall within the scope of the appended claims.

In the embodiments of the present application, the terms “first” and “second” etc., are used to distinguish different elements, but do not represent a spatial arrangement or temporal order, etc., of these elements, and these elements should not be limited by these terms. The term “and/or” includes any and all combinations of one or more associated listed terms. The terms “comprise”, “include”, “have”, etc., refer to the presence of described features, elements, components, or assemblies, but do not exclude the presence or addition of one or more other features, elements, components, or assemblies.

In the embodiments of the present application, the singular forms “a” and “the”, etc., include plural forms, and should be broadly construed as “a type of” or “a class of” rather than being limited to the meaning of “one”. Furthermore, the term “the” should be construed as including both the singular and plural forms, unless otherwise specified in the context. In addition, the term “according to” should be construed as “at least in part according to . . . ” and the term “on the basis of” should be construed as “at least in part on the basis of . . . ”, unless otherwise specified in the context.

In the embodiments of the present application, the term “landmark” may be equivalently replaced with “keypoint”, “key coordinate point”, or “landmark point”. The term “scan object” may be equivalently replaced with “object”, “object to be scanned”, “patient”, or “object being studied”, which may be a human being or an animal, or the like.

In the embodiments of the present application, the term “include/comprise” when used herein refers to the presence of features, integrated components, steps, or assemblies, but does not preclude the presence or addition of one or more other features, integrated components, steps, or assemblies.

The features described and/or illustrated for one implementation may be used in one or more other implementations in the same or similar manner, be combined with features in other embodiments, or replace features in other implementations.

In the embodiments of the present application, obtained landmark information (e.g., keypoint distribution information) is applicable to a variety of medical imaging scenarios, including, but not limited to, magnetic resonance imaging (MRI), computed tomography (CT), ultrasound imaging, positron emission computed tomography (PET), single photon emission computed tomography (SPECT), PET/CT, PET/MR, or any other suitable medical imaging scenarios.

In the embodiments of the present application, the method, apparatus and system of the present application are exemplarily described by taking an MRI scenario as an example. It should be understood that the contents of the embodiments of the present application also applies to other medical imaging scenarios.

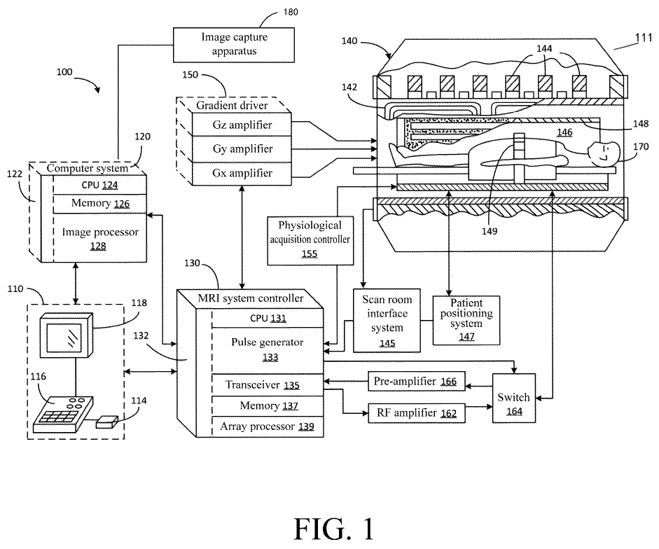

For ease of understanding, FIG. 1 is a schematic diagram of a magnetic resonance imaging (MRI) system 100 according to an embodiment of the present application.

The MRI system 100 includes a scanning unit 111. The scanning unit 111 is used to perform a magnetic resonance scan of a subject (e.g., a human body) 170 to generate image data of a region of interest of the subject 170, wherein the region of interest may be a pre-determined anatomical site or anatomical tissue.

The operation of the MRI system 100 is controlled by an operator workstation 110 that includes an input device 114, a control panel 116, and a display 118. The input device 114 may be a joystick, a keyboard, a mouse, a trackball, a touch-activated screen, voice control, or any similar or equivalent input device. The control panel 116 may include a keyboard, a touch-activated screen, voice control, a button, a slider, or any similar or equivalent control device. The operator workstation 110 is coupled to and in communication with a computer system 120 that enables an operator to control the generation and display of images on the display 118. The computer system 120 includes various components that communicate with one another via an electrical and/or data connection module 122. The connection module 122 may employ a direct wired connection, a fiber optic connection, a wireless communication link, etc. The computer system 120 may include a central processing unit (CPU) 124, a memory 126, and an image processor 128. In some embodiments, the image processor 128 may be replaced by image processing functions implemented in the CPU 124. The computer system 120 may be connected to an archive media device, a persistent or backup memory, or a network. The computer system 120 may be coupled to and communicates with a separate MRI system controller 130.

The MRI system controller 130 includes a set of components that communicate with one another via an electrical and/or data connection module 132. The connection module 132 may employ a direct wired connection, a fiber optic connection, a wireless communication link, etc. The MRI system controller 130 may include a CPU 131, a sequence pulse generator 133 (also known as a pulse generator) which is in communication with the operator workstation 110, a transceiver (also known as a RF transceiver) 135, a memory 137, and an array processor 139.

In some embodiments, the sequence pulse generator 133 may be integrated into a resonance assembly 140 of the scanning unit 111 of the MRI system 100. The MRI system controller 130 may receive a command from the operator workstation 110, and is coupled to the scanning unit 111 to indicate an MRI scanning sequence to be performed during an MRI scan, so as to be used to control the scanning unit 111 to perform the flow of the aforementioned magnetic resonance scan. The MRI system controller 130 is further coupled to and in communication with a gradient driver system (also known as a gradient driver) 150 which is coupled to a gradient coil assembly 142 to generate a magnetic field gradient during an MRI scan.

The sequence pulse generator 133 may further receive data from a physiological acquisition controller 155 that receives signals from a plurality of different sensors (e.g., electrocardiogram (ECG) signals from electrodes attached to a patient, etc.) connected to the subject or patient 170 undergoing an MRI scan. The sequence pulse generator 133 is coupled to and in communication with a scan room interface system 145 that receives signals from various sensors associated with the state of the resonance assembly 140. The scan room interface system 145 is further coupled to and in communication with a patient positioning system 147 that sends and receives signals to control movement of a patient table to a required position to perform the MRI scan.

The MRI system controller 130 provides a gradient waveform to the gradient driver system 150, and the gradient driver system includes Gₓ (x direction), G_{y} (y direction), G_{z} (z direction) amplifiers, etc. Each of the Gₓ, G_{y}, and G_{z} gradient amplifiers excites a corresponding gradient coil in the gradient coil assembly 142, so as to generate a magnetic field gradient used to spatially encode an MR signal during an MRI scan. The gradient coil assembly 142 is disposed within the resonance assembly 140, and the resonance assembly further includes a superconducting magnet having a superconducting coil 144 that, in operation, provides a static uniform longitudinal magnetic field B₀ throughout a cylindrical imaging volume 146. The resonance assembly 140 further includes an RF body coil 148 that, in operation, provides a transverse magnetic field B₁, and the transverse magnetic field B₁ is substantially perpendicular to B₀ throughout the entire cylindrical imaging volume 146. The resonance assembly 140 may further include an RF surface coil 149 for imaging different anatomical structures of the patient undergoing the MRI scan. The RF body coil 148 and the RF surface coil 149 may be configured to operate in a transmit and receive mode, a transmit mode, or a receive mode.

The x direction may also be referred to as a frequency encoding direction or a kₓ direction in the k-space, the y direction may be referred to as a phase encoding direction or a k_{y} direction in the k-space, and the z direction may be referred to as a layer surface selection (layer selection) direction. Gₓ can be used for frequency encoding or signal readout, and is generally referred to as a frequency encoding gradient or a readout gradient. G_{y} can be used for phase encoding, and is generally referred to as a phase encoding gradient. G_{z} can be used for slice (layer) position selection to acquire k-space data. It should be noted that a layer selection direction, a phase encoding direction, and a frequency encoding direction may be modified according to actual requirements.

The subject or patient 170 of the MRI scan may be positioned within the cylindrical imaging volume 146 of the resonance assembly 140. The transceiver 135 in the MRI system controller 130 generates RF excitation pulses that are amplified by an RF amplifier 162 and provided to the RF body coil 148 through a transmit/receive switch (also known as T/R switch or switch) 164.

As described above, the RF body coil 148 and the RF surface coil 149 may be used to transmit RF excitation pulses and/or receive resulting MR signals from the patient undergoing the MRI scan. The MR signals emitted by excited nuclei in the patient of the MRI scan may be sensed and received by the RF body coil 148 or the RF surface coil 149 and sent back to a pre-amplifier 166 through the T/R switch 164. The T/R switch 164 may be controlled by a signal from the sequence pulse generator 133 to electrically connect the RF amplifier 162 to the RF body coil 148 in the transmit mode and to connect the pre-amplifier 166 to the RF body coil 148 in the receive mode. The T/R switch 164 may further enable the RF surface coil 149 to be used in the transmit mode or the receive mode.

In some embodiments, the MR signals sensed and received by the RF body coil 148 or the RF surface coil 149 and amplified by the pre-amplifier 166 are stored in the memory 137 for post-processing as a raw k-space data array. A reconstructed magnetic resonance image may be obtained by transforming/processing the stored raw k-space data.

In some embodiments, the MR signals sensed and received by the RF body coil 148 or the RF surface coil 149 and amplified by the pre-amplifier 166 are demodulated, filtered, and digitized in a receiving portion of the transceiver 135, and transmitted to the memory 137 in the MRI system controller 130. For each image to be reconstructed, the data is rearranged into separate k-space data arrays, and each of said separate k-space data arrays is input to the array processor 139, the array processor being operated to transform the data into an array of image data by Fourier transform.

The array processor 139 uses transform methods, most commonly Fourier transform, to create images from the received MR signals. These images are transmitted to the computer system 120 and stored in the memory 126. In response to commands received from the operator workstation 110, the image data may be stored in a long-term memory, or may be further processed by the image processor 128 and transmitted to the operator workstation 110 for presentation on the display 118.

In various embodiments, components of the computer system 120 and the MRI system controller 130 may be implemented on the same computer system or on a plurality of computer systems. It should be understood that the MRI system 100 shown in FIG. 1 is intended for illustration. Suitable MRI systems may include more, fewer, and/or different components.

The MRI system controller 130 and the image processor 128 may separately or collectively include a computer processor and a storage medium. The storage medium records a predetermined data processing program to be executed by the computer processor. For example, the storage medium may store a program configured to implement scanning processing (such as a scanning flow and an imaging sequence), image reconstruction, medical imaging, and the like. For example, the storage medium may store a program configured to implement the magnetic resonance imaging method according to the embodiments of the present invention. The described storage medium may include, for example, a ROM, a floppy disk, a hard disk, an optical disk, a magneto-optical disk, a CD-ROM, or a non-volatile memory card.

The MRI system 100 further includes an image capture apparatus 180. The image capture apparatus 180 is configured to acquire information such as visual and morphological information of a scan object. In general, the image capture apparatus 180 may be mounted near an examination bed, thereby enabling image information of the scan object to be maximally collected in a non-contact manner. The image information may be used to assist with medical imaging operations. For example, the image information acquired by the image capture apparatus 180 may be used for landmark recognition so that a subsequent scanning operation may be performed according to a result of the landmark recognition.

The inventors have found that in some medical scenarios, it is necessary to cover the surface of the scan object with an obstruction (e.g., a coil, a blanket, complicated clothing, a mask, etc.). For example, in the MRI scenario as described above, it is necessary to cover the surface of the scan object with the RF surface coil 149. Since a partial region of the scan object is covered with an obstruction, the image capture apparatus 180 cannot acquire an image within the area of coverage. Therefore, when an image acquired by the image capture apparatus 180 is used for landmark recognition, it is likely to result in an inaccurate recognition result, thereby affecting a subsequent scanning result.

In view of at least one of the above problems, provided in the embodiments of the present application are a keypoint detection method for medical imaging, a medical imaging method and a medical imaging system.

Description is provided below in conjunction with the embodiments.

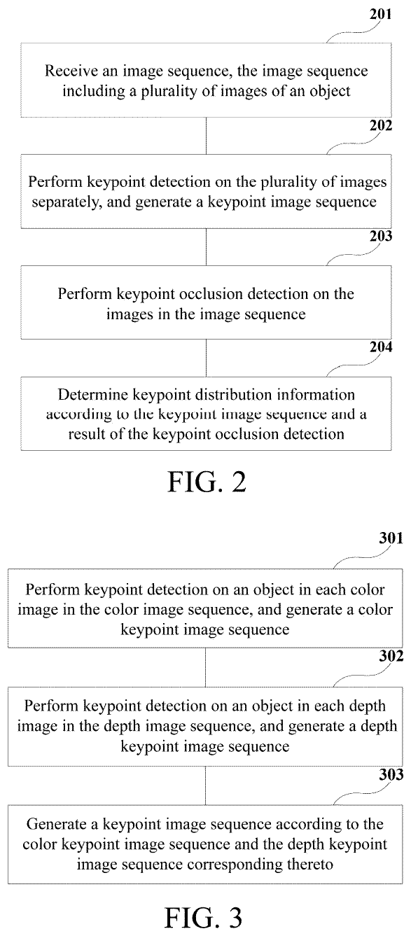

Provided in the embodiments of the present application is a keypoint detection method for medical imaging. FIG. 2 is a schematic diagram of a keypoint detection method for medical imaging according to an embodiment of the present application. As shown in FIG. 2, the method includes: at step 201: receiving an image sequence, the image sequence including a plurality of images of an object; and at step 202: performing keypoint detection on the plurality of images separately, and generating a keypoint image sequence.

The method further includes at step 203: performing keypoint occlusion detection on the images in the image sequence; and at step 204: determining keypoint distribution information according to the keypoint image sequence and a result of the keypoint occlusion detection.

According to the embodiment above, keypoint detection is performed on a plurality of images in an image sequence separately, a keypoint image sequence is generated, keypoint occlusion detection is performed on the plurality of images in the image sequence, and keypoint distribution information is determined according to the generated keypoint image sequence and a result of the keypoint occlusion detection. Thus, the accuracy and reliability of the keypoint distribution information can be improved.

In other words, in the process of determining the keypoint distribution information of a medical image, by considering image sequence information within a period of time, the method according to the present embodiment can improve the accuracy and reliability of the keypoint distribution information compared to methods in which keypoint distribution information is determined solely based on images acquired at a single point in time.

In some embodiments, the image sequence may be acquired by the image capture apparatus 180. The image sequence includes a plurality of images within a period of time.

In some embodiments, the images in the image sequence may be of various types. For example, the images may include a color image, or a depth image, or a color image and a depth image corresponding to each other in the time dimension. The color image and the depth image corresponding to each other in the time dimension may refer to a color image and a depth image acquired at the same time point.

In some embodiments, the color image may include a plurality of pixel points, and a value of each pixel point may include a value of each color component. The color components may include red, green, and blue (RGB) components and the like.

In some embodiments, the depth image may include a plurality of pixel points, and a value of each pixel point may include a depth value of the pixel. The depth value of the pixel may be a distance between the pixel and a reference plane, or the like. The reference plane is, for example, an image capture plane of the image capture apparatus 180.

In some embodiments, the image sequence may include a plurality of images capable of showing different areas of occlusion. Therefore, in the process of keypoint detection, more available information can be obtained from the plurality of images showing different areas of occlusion than from one or more images showing one area of occlusion.

For example, the image sequence may include at least one first image, and keypoints in at least a partial region of the first image are unoccluded. Therefore, even if the partial region is occluded by an occlusion at a later time point (an image in which the partial region is occluded is referred to as a second image), keypoint information in the partial region can be determined based on the information of the first image. The accuracy of keypoint recognition can be improved compared to determination of the keypoint information in the partial region only according to the second image.

The keypoint detection method for medical imaging according to the embodiment of the present application will be exemplarily described below by using images including color images and depth images corresponding to each other in the time dimension as an example (that is, an image sequence including a color image sequence and a depth image sequence corresponding to each other). It is to be understood that the following also applies to the case where the image includes only a color image or a depth image or other images.

In some embodiments, the color image sequence may include at least one first color image, and keypoints in at least a partial region of the first color image are unoccluded.

In some embodiments, the depth image sequence may include at least one first depth image, and keypoints in at least a partial region of the first depth image are unoccluded.

In some embodiments, at step 202, keypoint detection is performed on the plurality of images separately to generate a keypoint image sequence. The keypoint image sequence includes a plurality of keypoint images corresponding to the images in the image sequence. The keypoint images include at least one of the following information: position information, type information, confidence level information, etc. of keypoints.

In some embodiments, the keypoints may be, for example, feature points that are related to body parts and can be detected in the image.

The position information of the keypoint may be represented by a pixel position in the image. The present application is not limited thereto, and the position information of the keypoint may be represented in other manners.

The type of the keypoint may include at least one of the following: head, chest, abdomen, neck, nose, left shoulder, right shoulder, left hip, right hip, left eye, right eye, left elbow, right elbow, left knee, right knee, left ear, right ear, left wrist, right wrist, left ankle, and right ankle. The present application is not limited thereto, and the type of the keypoint may also include other content.

The confidence level information of the keypoint may be in the form of probability, referring to, for example, the probability that the actual position of the keypoint is located at the position resulting from detection. The present application is not limited thereto, and the confidence level information of the keypoint may also be in other forms or has other meanings.

In some embodiments, a single keypoint, or a plurality of keypoints and the position relations between them, may be used to position a site to be imaged on the object. For example, a region of interest to be imaged on the current object is determined and a relative position between the object and the center of a scanning device is adjusted to align a coordinate center of the determined region of interest with a scanning center of an imaging device.

In some embodiments, at step 202, the keypoint detection may include performing keypoint detection on a color image in the color image sequence and a depth image in the depth image sequence. Keypoint detection is performed on the color image to obtain a color keypoint image, and keypoint detection is performed on the depth image to obtain a depth keypoint image.

In some embodiments, the keypoint image sequence generated by keypoint detection may include a plurality of keypoint images. The plurality of keypoint images are arranged in chronological order, sequentially corresponding to the images in the image sequence.

In some embodiments, each of the keypoint images may include a color keypoint image and a depth keypoint image corresponding to each other. The present application is not limited thereto, and the keypoint image may also be generated according to a color keypoint image and a depth key image corresponding to each other.

FIG. 3 is a schematic diagram of an implementation of step 202 according to an embodiment of the present application. As shown in FIG. 3, the implementation of step 202 of FIG. 2 may include: at step 301: performing keypoint detection on an object in each color image in the color image sequence, and generating a color keypoint image sequence; and at step 302: performing keypoint detection on an object in each depth image in the depth image sequence, and generating a depth keypoint image sequence. Further at step 303: a keypoint image sequence is generated according to the color keypoint image sequence and the depth keypoint image sequence corresponding thereto.

In some embodiments, at steps 301 and 302, keypoint detection may be performed on the color images and the depth images in various manners to obtain the color keypoint image sequence and the depth keypoint image sequence, respectively.

For example, taking one color image in the color image sequence as an example, keypoint detection can be performed on the color image using a neural network model to generate a color keypoint image.

An input of the neural network may be a color image and an output of the neural network may be a color keypoint image including keypoint information. The keypoint information may include at least one of the following: position information, type information, confidence level information, etc. of keypoints. For the specific manner of performing keypoint detection using the neural network model, reference may be made to the related art, which will not be extensively described here.

Similarly, a depth keypoint image can be generated according to a depth image in the manner described above.

In some embodiments, at step 303, in the process of generating a keypoint image sequence according to the color keypoint image sequence and the corresponding depth keypoint image sequence: for one color keypoint image in the color keypoint image sequence and a corresponding depth keypoint image in the depth keypoint image sequence, according to the confidence level of a keypoint in the color keypoint image and the confidence level of a corresponding keypoint in the depth keypoint image, information of a corresponding keypoint in a corresponding keypoint image in the keypoint image sequence is determined.

For example, a keypoint having a high confidence level is selected among the corresponding keypoints in the color keypoint image and the depth keypoint image, and information (for example, position information) of that keypoint is taken as information of the keypoint in the corresponding keypoint image.

The color keypoint image and the depth keypoint image corresponding to each other may refer to the color keypoint image and the depth keypoint image being acquired at the same time point. That is, the color keypoint image and the depth keypoint image are temporally aligned. The keypoint image corresponding to the color keypoint image or the depth keypoint image may refer to a keypoint image generated according to the color keypoint image or the depth keypoint image.

A corresponding keypoint may refer to a keypoint of the same type. For example, a nose keypoint in the color keypoint image, a nose keypoint in the depth keypoint image, and a nose keypoint in the keypoint image correspond to each other.

In some embodiments, at step 202, pre-processing may further be included. The color image sequence and the depth image sequence may be generated after pre-processing a color stream and a depth stream. The pre-processing may include operations such as normalization, resizing, and data cleaning. Thus, the accuracy of keypoint detection can be improved.

In some embodiments, at step 202, post-processing may further be included. After keypoint detection is performed, a detection result of the keypoint detection may be post-processed to obtain the color keypoint image sequence and the depth keypoint image sequence. The post-processing may include keypoint de-noising processing. Thus, the accuracy of the keypoint image sequences can be improved. But the present application is not limited thereto. For example, at step 202, when the keypoint detection result obtained by directly using the original color image and depth image is sufficiently accurate, pre-processing or post-processing may not be included.

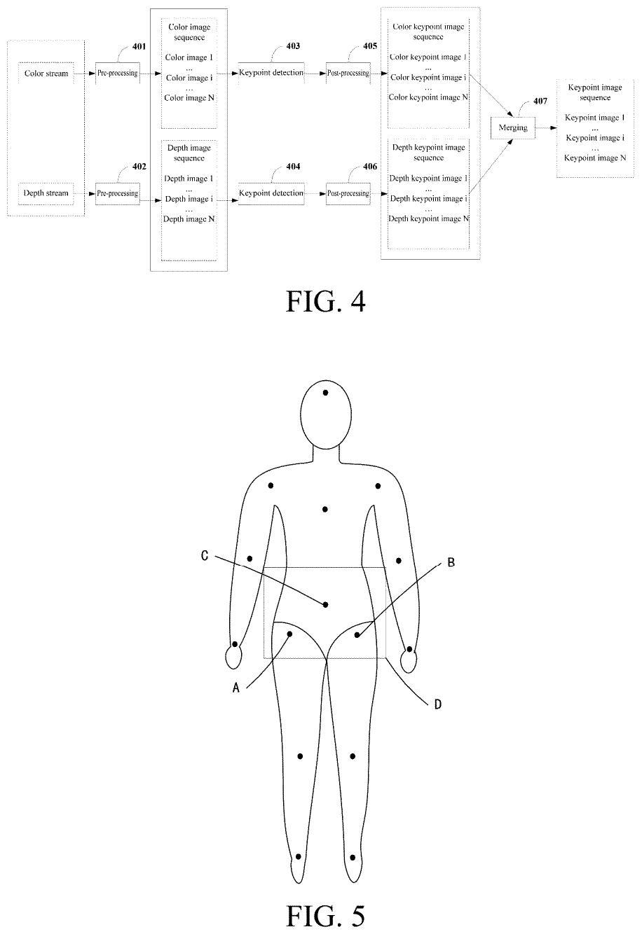

FIG. 4 is a schematic diagram of a flow of step 202 according to an embodiment of the present application. In FIG. 4, a dashed block indicates data, and a solid block indicates processing. As shown in FIG. 4, at step 202: a color stream and a depth stream are preprocessed (step 401 and step 402), respectively, to generate a color image sequence and a depth image sequence. The color image sequence includes N color images, and the depth image sequence includes N depth images, where a color image and a depth image of the same numbering correspond to each other. That is, an i-th color image corresponds to an i-th depth image, where N is greater than or equal to 1, and i is a positive integer less than or equal to N.

Keypoint detection is performed on each color image and each depth image separately (step 403 and step 404), and detection results of the keypoint detections are post-processed separately (step 405 and step 406) to generate the color keypoint image sequence and the depth keypoint image sequence. The color keypoint image sequence includes N color keypoint images, and the depth keypoint image sequence includes N depth keypoint images, where a color keypoint image and a depth keypoint image of the same numbering correspond to each other, a color keypoint image and a color image of the same numbering correspond to each other, and a depth keypoint image and a depth image of the same numbering correspond to each other.

The depth keypoint image sequence and the color keypoint image sequence are merged (step 407) to generate a keypoint image sequence. The keypoint image sequence includes N keypoint images, where a keypoint image, a color image keypoint image, and a depth keypoint image of the same numbering correspond to each other.

At step 407, for keypoints of the same type in the i-th color keypoint image and the i-th depth keypoint image, a keypoint having a high confidence level is selected as a keypoint for said type in the i-th keypoint image. For example, when the confidence level of a nose keypoint in the i-th color keypoint image is 80% and the confidence level of a nose keypoint in the i-th depth keypoint image is 60%, the nose keypoint in the i-th color keypoint image is taken as a nose keypoint in the i-th keypoint image. That is, the position information of the nose keypoint in the i-th keypoint image is the position information of the nose keypoint in the i-th color keypoint image.

In some embodiments, at step 203, keypoint occlusion detection is performed on the images in the image sequence. For example, the keypoint occlusion detection may be performed on the color images in the color image sequence and the depth images in the depth image sequence, and the result of the keypoint detection may be taken as occlusion information.

The keypoint occlusion detection may include detecting an occlusion state of the keypoint and time information of a change in the occlusion state.

FIG. 5 is a schematic diagram of an occlusion state of a keypoint according to an embodiment of the present application. As shown in FIG. 5, a neural network model may detect 15 keypoints. In the case where a partial region of an object under detection is occluded by an occlusion, keypoints in the partial region are in an occluded state, and keypoints in the other partial regions are in an unoccluded state.

For example, as shown in FIG. 5, an abdominal region of the object under detection is occluded by a blanket. An abdominal keypoint C, a left hip keypoint B, and a right hip keypoint A in the region are occluded, and the other keypoints are unoccluded.

The occlusion information may be used to indicate an occlusion state of a keypoint of the object and time information of a change in the occlusion state. The occlusion detection may be performed in various manners such as by image recognition and neural networks. For instance, taking a color image as an example, an occluded area of an object in the color image may be determined by image recognition, and then a keypoint in the occluded area may be determined according to a result of keypoint detection on the color image by a neural network. Alternatively, an occluded keypoint of an object in the color image may be determined directly according to a result of keypoint detection on the color image by a neural network (e.g., a keypoint undetected or a keypoint having a lower confidence level is taken as the occluded keypoint). An input of the neural network may be a color image, and an output of the neural network may be occluded keypoint type information, etc. For the specific manner of keypoint detection and determination of occluded areas/keypoints, reference may be made to the related art, which will not be extensively described here.

In some embodiments, the occlusion state of a keypoint of an object and the time information of a change in the occlusion state may be represented in various forms. For example, the occlusion information may include the occlusion state of each keypoint at each time point. Table 1 shows an example of the occlusion information.

TABLE 1

| | Time point 1 | . . . | Time point i | . . . | Time point N |
|---|---|---|---|---|---|
| Keypoint 1 | 1 | . . . | 0 | . . . | 1 |
| . . . | . . . | . . . | . . . | . . . | . . . |
| Keypoint j | 1 | . . . | 1 | . . . | 0 |
| . . . | . . . | . . . | . . . | . . . | . . . |
| Keypoint M | 1 | . . . | 0 | . . . | 0 |

In Table 1, N is the number of color images or depth images, M is the total number of keypoints that can be detected by the neural network model, 0 in the table indicates that the keypoint is occluded at a certain time point (frame), and 1 in the table indicates that the keypoint is unoccluded at a certain time point (frame).

For another example, the occlusion information may include an occlusion state of each keypoint at the last time point, and for a keypoint that is occluded at the last time point, the occlusion information further includes the time when the occlusion state of the keypoint changes from unoccluded to occluded. In the case where the time includes a plurality of times, it is possible to indicate only the last time.

For example, in the occlusion information, only the occlusion state of each keypoint in a N-th keypoint image is indicated. Taking an occluded keypoint in the N-th keypoint image as an example, if the keypoint is unoccluded in an i-th image and occluded in an (i+1)-th image, then a time point corresponding to the i-th image or a time point corresponding to the (i+1)-th image is indicated in the occlusion information for the keypoint. Alternatively, if the keypoint is unoccluded in the i-th image and occluded in the (i+1)-th image, and is unoccluded in a j-th image and occluded in a (j+1)-th image, where j is greater than i, then a time point corresponding to the j-th image or a time point corresponding to the (j+1)-th image is indicated in the occlusion information for the keypoint. The present application is not limited thereto, and the occlusion information may also be other forms of information as long as it can indicate the occlusion state of the keypoint and the time information.

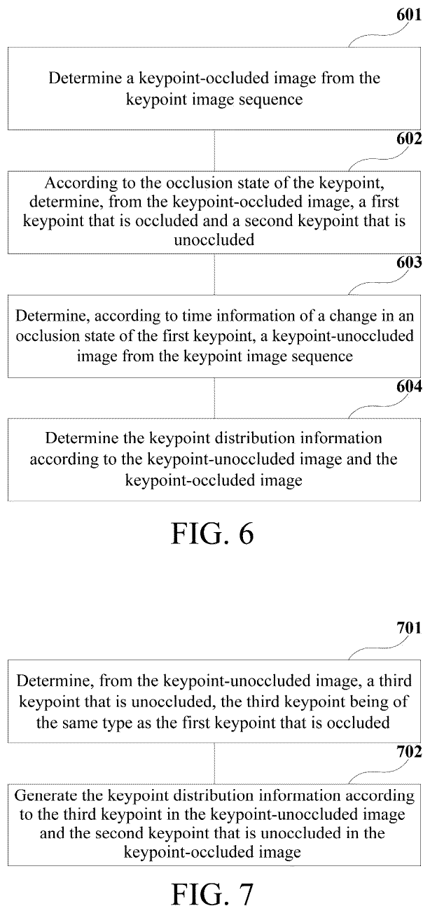

In some embodiments, at step 204, the keypoint distribution information is determined according to the keypoint image sequence obtained at step 202 and the result of keypoint occlusion detection (i.e., occlusion information) obtained at step 203. FIG. 6 is a schematic diagram of an implementation of step 204 according to an embodiment of the present application. As shown in FIG. 6, the implementation of step 204 may include: at step 601: determining a keypoint-occluded image from the keypoint image sequence and at step 602: according to the occlusion state of the keypoint, determining, from the keypoint-occluded image, a first keypoint that is occluded and a second keypoint that is unoccluded. The implementation of step 204 further includes at step 603: determining, according to time information of a change in an occlusion state of the first keypoint, a keypoint-unoccluded image from the keypoint image sequence; and at step 604: determining the keypoint distribution information according to the keypoint-unoccluded image and the keypoint-occluded image.

For the first keypoint that is occluded in the keypoint-occluded image, the keypoint-unoccluded image is determined from the keypoint image sequence, and the keypoint distribution information is generated according to the keypoint-occluded image and the keypoint-unoccluded image, which can improve the accuracy and reliability of the keypoint distribution information.

In some embodiments, at step 601, the keypoint-occluded image may be the last keypoint image, e.g., the N-th keypoint image, in the keypoint image sequence. Since the last keypoint image is the keypoint image closest to the current time, the keypoint distribution information determined based on the last keypoint image can reflect the current position information of an object more accurately. But the present application is not limited thereto, and the keypoint-occluded image may also be any one or more keypoint images in the keypoint image sequence.

In some embodiments, in the keypoint-occluded image, at least some keypoints are occluded, such that the keypoints in the image are not detected or the detected keypoints have a lower confidence level.

In some embodiments, at step 602, a first keypoint that is occluded and a second keypoint that is unoccluded in the keypoint-occluded image are determined according to the result of the keypoint occlusion detection.

In some embodiments, at step 603, for each occluded first keypoint in the keypoint-occluded image, a keypoint-unoccluded image corresponding to the first keypoint is separately determined. For example, in the keypoint-occluded image, a chest keypoint and an abdomen keypoint are occluded; using the chest keypoint as a reference, a keypoint-unoccluded image for the chest keypoint is determined from the keypoint image sequence; and using the abdomen keypoint as a reference, a keypoint-unoccluded image for the abdomen keypoint is determined from the keypoint image sequence.

In some embodiments, in the keypoint-unoccluded image, the keypoint corresponding to the first keypoint is unoccluded, such that the keypoint in the image is detected or the detected keypoint has a higher confidence level.

In some embodiments, the keypoint-unoccluded image is the following keypoint image in the keypoint image sequence: in the keypoint-unoccluded image, keypoints of the same type as the first keypoint are unoccluded, and in the time dimension of the keypoint image sequence, the keypoint-unoccluded image is closest to the keypoint-occluded image.

For example, the keypoint image sequence has a total of 10 keypoint images, and the keypoint-occluded image is the tenth keypoint image. In the tenth keypoint image, the chest keypoint is occluded. According to the time information of the change in the occluded state of the chest keypoint, for example, 1111100000 (i.e., the chest keypoint is unoccluded in the first to fifth images or time points and occluded in the sixth to tenth images or time points), the fifth keypoint image is selected as the keypoint-unoccluded image of the chest keypoint.

For another example, when the time information of the change in the occluded state of the chest keypoint is 111110110 (i.e., the chest keypoint is unoccluded in the first to fifth and eighth to ninth images or time points and occluded in the sixth and tenth images or time points), the ninth keypoint image is selected as the keypoint-unoccluded image of the chest keypoint.

As previously mentioned, for one first keypoint, the keypoint-unoccluded image is one keypoint image determined in the foregoing manner. But the present application is not limited thereto. For one first keypoint, the keypoint-unoccluded image may also be a plurality of keypoint images.

For example, the keypoint-unoccluded image may be a keypoint image where keypoints of the same type as the first keypoint are unoccluded, and its distance in the time dimension from the keypoint-occluded image is less than a preset distance. For example, when the time information of the change in the occluded state of the chest keypoint is 111110110, the eighth and ninth keypoint images, in which the chest keypoint is unoccluded and the time interval from the keypoint-occluded image (tenth keypoint image) is less than 3 images, are selected as the keypoint-unoccluded images of the chest keypoint.

In some embodiments, at step 604, the keypoint distribution information may be generated according to the keypoint-unoccluded image and the keypoint-occluded image in various manners. FIG. 7 is a schematic diagram of an implementation of step 604 according to an embodiment of the present application. As shown in FIG. 7, the implementation of step 604 may include: at step 701: determining, from the keypoint-unoccluded image, a third keypoint that is unoccluded, the third keypoint being of the same type as the first keypoint that is occluded; and at step 702: generating the keypoint distribution information according to the third keypoint in the keypoint-unoccluded image and the second keypoint that is unoccluded in the keypoint-occluded image.

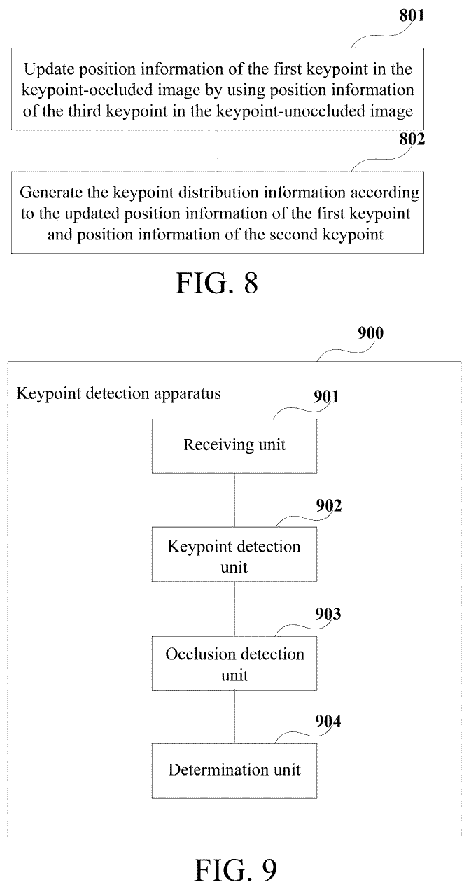

In some embodiments, at step 702, the keypoint distribution information may be determined in various manners. FIG. 8 is a schematic diagram of an implementation of step 702 according to an embodiment of the present application. As shown in FIG. 8, the implementation of step 702 may include: at step 801: updating position information of the first keypoint in the keypoint-occluded image by using position information of the third keypoint in the keypoint-unoccluded image; and at step 802: generating the keypoint distribution information according to the updated position information of the first keypoint and position information of the second keypoint.

Since the third keypoint in the keypoint-unoccluded image is unoccluded, the reliability of the position information of the third keypoint is higher. By replacing the position information of the first keypoint in the keypoint-occluded image with the position information of the third keypoint in the keypoint-unoccluded image, and generating the keypoint distribution information according to the updated position information of the first keypoint, the accuracy of the keypoint distribution information can be improved.

In some embodiments, the keypoint distribution information may include the updated position information of the first keypoint and the position information of the second keypoint.

The present application is not limited thereto, and the position information of the first keypoint may be updated in other manners. For example, the position information of the first keypoint and the position information of the third keypoint may be weighted, e.g., weighted according to the confidence levels, and a result of weighting is taken as the updated position information of the first keypoint, and so on.

In addition, when the keypoint-unoccluded image includes a plurality of keypoint images, the position information of the first keypoint may be updated according to the position information of a plurality of third keypoints in the plurality of keypoint images. For example, the position information of the plurality of third keypoints may be weighted, or the position information of the first keypoint and the position information of the plurality of third keypoints may be weighted, and a result of weighting may be taken as the updated position information of the first keypoint, and so on.

According to the embodiment above, keypoint detection is performed on a plurality of images in an image sequence separately, a keypoint image sequence is generated, keypoint occlusion detection is performed on the plurality of images in the image sequence, and keypoint distribution information is determined according to the generated keypoint image sequence and a result of the keypoint occlusion detection. Thus, the accuracy and reliability of the keypoint distribution information can be improved.

In other words, in the process of determining the keypoint distribution information of a medical image, by considering image sequence information within a period of time, the method according to the present embodiment can improve the accuracy and reliability of the keypoint distribution information compared to methods in which keypoint distribution information is determined solely based on images acquired at a single point in time.

Further provided in the embodiments of the present application is a keypoint detection apparatus for medical imaging, of which the same content as that of the above-mentioned embodiments will not be repeated.

FIG. 9 is a schematic diagram of a keypoint detection apparatus for medical imaging according to an embodiment of the present application. As shown in FIG. 9, a keypoint detection apparatus 900 for medical imaging includes: a receiving unit 901, receiving an image sequence, the image sequence including a plurality of images of an object; and a keypoint detection unit 902, performing keypoint detection on the plurality of images separately, and generating a keypoint image sequence. The keypoint detection apparatus 900 further includes an occlusion detection unit 903, performing keypoint occlusion detection on the images in the image sequence; and a determination unit 904, determining keypoint distribution information according to the keypoint image sequence and a result of the keypoint occlusion detection.

In some embodiments, the image sequence includes at least one first image, and keypoints in at least a partial region of the first image are unoccluded.

In some embodiments, the image sequence includes a color image sequence and a depth image sequence corresponding to each other, and the keypoint detection includes performing keypoint detection on a color image in the color image sequence and a depth image in the depth image sequence.

In some embodiments, the color image sequence includes at least one first color image, and keypoints in at least a partial region of the first color image are unoccluded.

In some embodiments, the depth image sequence includes at least one first depth image, and keypoints in at least a partial region of the first depth image are unoccluded.

In some embodiments, the keypoint image sequence includes a plurality of keypoint images. Each of the keypoint images includes a color keypoint image and a depth keypoint image corresponding to each other.

In some embodiments, the keypoint occlusion detection includes detecting an occlusion state of the keypoint and time information of a change in the occlusion state.

In some embodiments, the determination unit 904 determines a keypoint-occluded image from the keypoint image sequence; according to the occlusion state of the keypoint, determines, from the keypoint-occluded image, a first keypoint that is occluded and a second keypoint that is unoccluded; determines, according to time information of a change in an occlusion state of the first keypoint, a keypoint-unoccluded image from the keypoint image sequence; and determines the keypoint distribution information according to the keypoint-unoccluded image and the keypoint-occluded image.

In some embodiments, the keypoint-occluded image is the last image in the keypoint image sequence.

In some embodiments, in the keypoint-unoccluded image, keypoints of the same type as the first keypoint are unoccluded, and in the time dimension of the keypoint image sequence, the keypoint-unoccluded image is closest to the keypoint-occluded image.

In some embodiments, the determination unit 904 determines, from the keypoint-unoccluded image, a third keypoint that is unoccluded, the third keypoint being of the same type as the first keypoint that is occluded; and generates the keypoint distribution information according to the third keypoint in the keypoint-unoccluded image and the second keypoint that is unoccluded in the keypoint-occluded image.

In some embodiments, the determination unit 904 updates position information of the first keypoint in the keypoint-occluded image by using position information of the third keypoint in the keypoint-unoccluded image; and generates the keypoint distribution information according to the updated position information of the first keypoint and position information of the second keypoint.

It is worth noting that only components or modules related to the present application are described above, but the present application is not limited thereto. The keypoint detection apparatus 900 for medical imaging may further include other components or modules. For the specifics of these components or modules, reference can be made to the related art.

For the sake of simplicity, FIG. 9 only exemplarily illustrates the connection relationship or signal direction between various components or modules, but it should be clear to those skilled in the art that a variety of related art such as bus connection can be used. The various components or modules can be implemented by means of hardware such as a processor or a memory, etc. The embodiments of the present application are not limited thereto.

The above embodiments merely provide illustrative descriptions of the embodiments of the present application. However, the present application is not limited thereto, and appropriate variations may be made on the basis of the above embodiments. For example, each of the above embodiments may be used independently, or one or more among the above embodiments may be combined.

According to the embodiment above, keypoint detection is performed on a plurality of images in an image sequence separately, a keypoint image sequence is generated, keypoint occlusion detection is performed on the plurality of images in the image sequence, and keypoint distribution information is determined according to the generated keypoint image sequence and a result of the keypoint occlusion detection. Thus, the accuracy and reliability of the keypoint distribution information can be improved.

In other words, in the process of determining the keypoint distribution information of a medical image, by considering image sequence information within a period of time, the method according to the present embodiment can improve the accuracy and reliability of the keypoint distribution information compared to methods in which keypoint distribution information is determined solely based on images acquired at a single point in time.

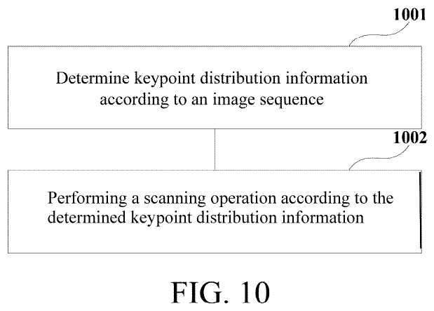

Further provided in the embodiments of the present application is a medical imaging method. FIG. 10 is a schematic diagram of a medical imaging method according to an embodiment of the present application. As shown in FIG. 10, the medical imaging method includes: at step 1001: determining keypoint distribution information according to an image sequence; and at step 1002: performing a scanning operation according to the determined keypoint distribution information.

At step 1001, the keypoint distribution information may be determined according to the keypoint detection method for medical imaging described in the aforementioned embodiments. The contents thereof are incorporated herein and will not be extensively described.

In some embodiments, at step 1002, performing the scanning operation according to the determined keypoint distribution information may include positioning the scan object according to the keypoint distribution information. For contents related to positioning, reference can be made to the related contents or related art in the aforementioned embodiments. The contents thereof are incorporated herein and will not be extensively described.

In some embodiments, step 1002 may further include performing a scanning operation on the positioned scan object.

According to the above embodiment, since the keypoint distribution information is determined using the keypoint detection method for medical imaging described in the aforementioned embodiments, the keypoint distribution information has higher accuracy and reliability. In the case where a scanning operation is performed according to the keypoint distribution information, the accuracy and reliability of scanning results can be ensured.

Further provided in the embodiments of the present application is a medical imaging system. The configuration of the medical imaging system is as shown in FIG. 1, and repeated description will not be provided.

In some embodiments, unlike the medical imaging system in FIG. 1, the controller 130 is configured to perform the keypoint detection method for medical imaging described previously, that is, receiving an image sequence, the image sequence including a plurality of images of an object; performing keypoint detection on the plurality of images separately, and generating a keypoint image sequence; performing keypoint occlusion detection on the images in the image sequence; and determining keypoint distribution information according to the keypoint image sequence and a result of the keypoint occlusion detection.

In some embodiments, the controller 130 (which may also be a processor) includes a computer processor and a storage medium. The storage medium records a predetermined data processing program to be executed by the computer processor. For example, the storage medium may store a program configured to implement scanning processing (for example, including waveform design/conversion), image reconstruction, medical imaging, and the like. For example, the storage medium may store a program configured to implement the keypoint detection method for medical imaging according to the embodiments of the present invention. The keypoint detection method for medical imaging includes: receiving an image sequence, the image sequence including a plurality of images of an object; performing keypoint detection on the plurality of images separately, and generating a keypoint image sequence; performing keypoint occlusion detection on the images in the image sequence; and determining keypoint distribution information according to the keypoint image sequence and a result of the keypoint occlusion detection. The specific embodiments thereof are as described above, and will not be repeated here. The described storage medium may include, for example, a ROM, a floppy disk, a hard disk, an optical disk, a magneto-optical disk, a CD-ROM, or a non-volatile memory card.

The present application is not limited thereto, and the keypoint detection method for medical imaging may also be performed in other processors in the MRI system 100, or by a cloud processor.

In some embodiments, a scanning assembly may perform a scanning operation according to keypoint distribution information determined by the controller 130. The scanning assembly may include a positioning assembly that may position the scan object according to the keypoint distribution information. The positioning assembly is, for example, the patient positioning system 147 of the MRI system 100.

In some embodiments, the scanning assembly may further include a scanning unit 111 that performs a scanning operation on the positioned scan object.

According to the embodiment above, keypoint detection is performed on a plurality of images in an image sequence separately, a keypoint image sequence is generated, keypoint occlusion detection is performed on the plurality of images in the image sequence, and keypoint distribution information is determined according to the generated keypoint image sequence and a result of the keypoint occlusion detection. Thus, the accuracy and reliability of the keypoint distribution information can be improved.

In other words, in the process of determining the keypoint distribution information of a medical image, by considering image sequence information within a period of time, the method according to the present embodiment can improve the accuracy and reliability of the keypoint distribution information compared to methods in which keypoint distribution information is determined solely based on images acquired at a single point in time.

Further provided in the embodiments of the present application is a computer-readable program. The computer-readable program, when executed in a medical imaging system, causes a computer to execute, in the medical imaging system, the keypoint detection method for medical imaging described in the aforementioned embodiments.

Further provided in the embodiments of the present application is a storage medium having a computer-readable program stored therein. The computer-readable program causes a computer to perform, in a medical imaging system, the medical imaging method described in the aforementioned embodiments.

The above apparatus and method of the present application can be implemented by hardware, or can be implemented by hardware in combination with software. The present application relates to the foregoing type of computer-readable program. When executed by a logic component, the program causes the logic component to implement the foregoing apparatus or constituent components thereof, or causes the logic component to implement various methods or steps as described above. The present application further relates to a storage medium for storing the above program, such as a hard disk, a disk, an optical disk, a DVD, a flash memory, etc.

The method/apparatus described in view of the embodiments of the present application may be directly embodied as hardware, a software module executed by a processor, or a combination of the two. For example, one or more of the functional block diagrams and/or one or more combinations of the functional block diagrams shown in the drawings may correspond to either respective software modules or respective hardware modules of a computer program flow. The foregoing software modules may respectively correspond to the steps shown in the figures. The foregoing hardware modules can be implemented, for example, by firming the software modules using a field-programmable gate array (FPGA).

The software modules may be located in a RAM, a flash memory, a ROM, an EPROM, an EEPROM, a register, a hard disk, a portable storage disk, a CD-ROM, or any other form of storage medium known in the art. The storage medium may be coupled to a processor, thereby enabling the processor to read information from the storage medium and can write information into the storage medium. Alternatively, the storage medium may be a constituent component of the processor. The processor and the storage medium may be located in an ASIC. The software module may be stored in a memory of a mobile terminal, and may also be stored in a memory card that can be inserted into a mobile terminal. For example, if a device (such as a mobile terminal) uses a large-capacity MEGA-SIM card or a large-capacity flash memory device, the software modules can be stored in the MEGA-SIM card or the large-capacity flash memory apparatus.

One or more of the functional blocks and/or one or more combinations of the functional blocks shown in the accompanying drawings may be implemented as a general-purpose processor, a digital signal processor (DSP), an application-specific integrated circuit (ASIC), a field-programmable gate array (FPGA) or other programmable logic devices, discrete gate or transistor logic devices, a discrete hardware assembly, or any appropriate combination thereof for implementing the functions described in the present application. The one or more functional blocks and/or the one or more combinations of the functional blocks shown in the accompanying drawings may also be implemented as a combination of computing devices, such as a combination of a DSP and a microprocessor, multiple microprocessors, one or more microprocessors in communication combination with a DSP, or any other such configuration.

The present application is described above with reference to specific embodiments. However, it should be clear to those skilled in the art that the foregoing description is merely illustrative and is not intended to limit the scope of protection of the present application. Various variations and modifications may be made by those skilled in the art according to the principle of the present application, and said variations and modifications also fall within the scope of the present application.

1. A keypoint detection method for medical imaging, characterized by comprising:
receiving an image sequence, the image sequence comprising a plurality of images of an object;
performing keypoint detection on the plurality of images separately, and generating a keypoint image sequence;
performing keypoint occlusion detection on the images in the image sequence; and
determining keypoint distribution information according to the keypoint image sequence and a result of the keypoint occlusion detection.

2. The method according to claim 1, wherein
the image sequence comprises at least one first image, keypoints in at least a partial region of the first image being unoccluded.

3. The method according to claim 1, wherein
the image sequence comprises a color image sequence and a depth image sequence corresponding to each other, and the keypoint detection comprises performing keypoint detection on a color image in the color image sequence and a depth image in the depth image sequence.

4. The method according to claim 3, wherein
the color image sequence comprises at least one first color image, keypoints in at least a partial region of the first color image being unoccluded.

5. The method according to claim 3, wherein
the depth image sequence comprises at least one first depth image, keypoints in at least a partial region of the first depth image being unoccluded.

6. The method according to claim 1, wherein
the keypoint image sequence comprises a plurality of keypoint images, wherein each of the keypoint images comprises a color keypoint image and a depth keypoint image corresponding to each other.

7. The method according to claim 1, wherein
the keypoint occlusion detection comprises detecting an occlusion state of a keypoint and time information of a change in the occlusion state.

8. The method according to claim 7, wherein determining the keypoint distribution information according to the keypoint image sequence and the result of the keypoint occlusion detection comprises:
determining a keypoint-occluded image from the keypoint image sequence;
according to the occlusion state of the keypoint, determining, from the keypoint-occluded image, a first keypoint that is occluded and a second keypoint that is unoccluded;
determining, according to time information of a change in an occlusion state of the first keypoint, a keypoint-unoccluded image from the keypoint image sequence; and
determining the keypoint distribution information according to the keypoint-unoccluded image and the keypoint-occluded image.

9. The method according to claim 8, wherein
the keypoint-occluded image is the last keypoint image in the keypoint image sequence.

10. The method according to claim 8, wherein
in the keypoint-unoccluded image, keypoints of the same type as the first keypoint are unoccluded, and in the time dimension of the keypoint image sequence, the keypoint-unoccluded image is closest to the keypoint-occluded image.

11. The method according to claim 8, wherein determining the keypoint distribution information according to the keypoint-unoccluded image and the keypoint-occluded image comprises:
determining, from the keypoint-unoccluded image, a third keypoint that is unoccluded, the third keypoint being of the same type as the first keypoint that is occluded; and
generating the keypoint distribution information according to the third keypoint in the keypoint-unoccluded image and the second keypoint that is unoccluded in the keypoint-occluded image.

12. The method according to claim 11, wherein generating the keypoint distribution information according to the third keypoint in the keypoint-unoccluded image and the second keypoint that is unoccluded in the keypoint-occluded image comprises:
updating position information of the first keypoint in the keypoint-occluded image by using position information of the third keypoint in the keypoint-unoccluded image; and
generating the keypoint distribution information according to the updated position information of the first keypoint and position information of the second keypoint.

13. A medical imaging method, comprising:
determining keypoint distribution information on the basis of the method according to claim 1; and
performing a scanning operation according to the determined keypoint distribution information.

14. The method according to claim 13, wherein performing the scanning operation according to the determined keypoint distribution information comprises:
positioning the scan object according to the keypoint distribution information.

15. A medical imaging system, comprising:
a controller, configured to perform the keypoint detection method for medical imaging according to claim 1; and
a scanning assembly, performing a scanning operation according to keypoint distribution information determined by the controller.

16. The medical imaging system according to claim 15, wherein the scanning assembly comprises:
a positioning assembly, positioning the scan object according to the keypoint distribution information.
